(19) United States
(12) Patent Application Publication
(10) Pub. No.: US 2011/0113438 A1
(43) Pub. Date: May 12, 2011

(54) METHOD AND SYSTEM OF DISPLAYING INFORMATION OF SPECIFIC INTEREST TO A USER ON A TELEVISION

(75) Inventors: ABHISHEK PATIL, San Diego, CA (US); DIPENDU SAHA, San Diego, CA (US); XIANGPENG JING, Jersey City, NJ (US); ANDY NGUYEN, San Diego, CA (US); AIXIN LIU, San Diego, CA (US); DJ NGUYEN, San Diego, CA (US)

(73) Assignee: SONY CORPORATION, Tokyo (JP)

(21) Appl. No.: 12/886,454

(22) Filed: Sep. 20, 2010

Related U.S. Application Data
(60) Provisional application No. 61/258,726, filed on Nov. 6, 2009.

(51) Int. Cl. H04N 7/16; H04N 5/445

(52) U.S. Cl. 725/1; 725/40

(57) ABSTRACT

A system and method of displaying information of specific interest to a user includes: rendering content on a television for a user and displaying first information on the television about the content, in response to a request from the user. In response to an additional request from the user, second information is displayed on the television about the first information, wherein the second information is acquired from a real time server conducted search. Purchase information is displayed on the television for products associated with the second information. In response to the user selecting the purchase information, a purchase transaction is initiated on the television. In some embodiments, a server records the purchase transactions and delivers targeted advertising to the television.

### CROSS REFERENCE TO RELATED APPLICATION

The present application claims priority from U.S. Provisional Patent Application No. 61/258,726, which was filed on Nov. 6, 2009, by Patil et al., for SONY 1-CLICK: CONTEXT SEARCHING AND PURCHASING SYSTEM FOR BIVL SERVICES, which provisional application is hereby incorporated by reference as though fully set forth herein.

### FIELD

Embodiments according to the present invention generally relate to televisions, in particular to television commerce.

### BACKGROUND

Local area home networks typically contain a number of networked devices. Each networked device stores data associated with the device. For example, home users store and access programming related information on television equipment, web page information on home computers, gaming information on game consoles, etc.

As the amount of information available on the internet increases, a home user can find information that is related to data stored across several devices in a home network. For example, a home user may purchase and watch a television program or movie using home television equipment. In addition, the home user may perform an internet search on a computer to find and purchase products related to a movie, e.g. shirts, coffee mugs, toys, etc.

However, there is no system available that allows the home user to access such related information easily and seamlessly. For example, the home user must manually perform an internet search about a television program on a computer separate from the television viewing device. In addition, the home user must identify key words for the search and filter through a number of possibly non-relevant web sites. Thus, the user is forced to comprehend and analyze large quantities of information to identify and access the exact interest of the user.

Likewise, conventional television equipment is poorly suited to allow internet searches. For example, televisions do not use keyboards, and home users typically prefer smaller remote controls that do not add clutter to a living room. In addition, entering a keyword internet search without use of a keyboard is a very time consuming and frustrating process, especially for searches requiring a number of keywords. Furthermore, to conduct an internet search conventional television equipment would need to be connected to a running computer that could perform the search. Such internet searching would be time consuming, frustrating, and would result in few online sales of television related merchandise.

### SUMMARY

Embodiments of the invention provide a special user display on a television that can include content related to a program that the user is currently viewing. The content can be compiled via an internet search conducted by a remote server in communication with the television. The search can be done based on Electronic Programming Guide (“EPG”) information related to the viewed program. The displayed content can include information related to the program, such as actors, producer, year or production, etc., and/or the content may include items that can be purchased that are related to the program, e.g. a DVD of the movie, memorabilia, etc. The remote server can also be used to orchestrate any purchase via direct connections to prescribed suppliers, e.g. Amazon, eBay, etc., so that the viewer can perform the total transaction by merely interfacing with the user display on the television, e.g. via a remote control device.

Embodiments of the present invention are directed to a method and system for displaying information of specific interest to a user. In one embodiment, a method of displaying information of specific interest to a user includes: rendering content on a television for a user; in response to a request from the user, displaying first information on the television about the content; in response to an additional request from the user, displaying second information on the television about the first information, wherein the second information is acquired from a real time server conducted search; displaying purchase information on the television for products associated with the second information; and in response to the user selecting the purchase information, initiating a purchase transaction on the television.

In one embodiment, the displaying the first information includes displaying title information, actor information, description information, and date information. In various embodiments, the displaying second information includes displaying a number of titles within a common genre, a number of titles an actor has appeared in, or a number of titles a director has directed.

In further embodiments, the products include recorded media of television shows, recorded media of movies, or consumer products. In some embodiments, the real time server conducted search uses close captioning information or meta data related to the content to perform the search. In other embodiments, the rendering content includes displaying a television show or a movie.

In another embodiment, a method of displaying information of specific interest to a user includes: displaying a user selected program on a television; in response to input from a user operated remote control device, rendering data on the television connected to the user selected program; rendering e-commerce information on the television for e-commerce items connected to the data; and in response to a user initiated e-purchase transaction on the television, initiating the e-purchase transaction.

In some embodiments, the rendering data includes rendering a number of programs within a common genre, programs with a common actor, or programs with related directors. In various embodiments, the user operated remote control device is a I/R remote control, a LAN remote control, or an application on a smart phone.

In one embodiment, the e-commerce items include recorded media of television shows, recorded media of movies, or consumer products. In further embodiments, the displaying a user selected program includes displaying a television program or a movie.

In some embodiments, the method includes receiving the data over the internet from a server. In various embodiments, the method includes: communicating the user initiated e-commerce transaction to a server; receiving advertising related to the user initiated e-commerce transaction; and communicating the advertising to the user.

In another embodiment, a television includes: a processor; a display device coupled to the processor; an input device wirelessly connected to the processor; and memory coupled to the processor. The memory includes instructions that when executed cause the system to perform a method of displaying information of specific interest to a user.

The method includes: rendering content on the display device for a user; in response to a request from the user, displaying first information on the display about the content; in response to an additional request from the user, displaying second information on the display about the first information, wherein the second information is acquired from a real time server conducted search; displaying purchase information on the display for products associated with the second information; and in response to the user selecting the purchase information, initiating a purchase transaction.

In some embodiments, the displaying first information includes displaying title information, actor information, description information, and date information. In other embodiments, the displaying second information includes displaying a plurality of titles within a common genre, a plurality of titles an actor has appeared in, or a plurality of titles a director has directed.

In various embodiments, the products include recorded media of television shows, recorded media of movies, or consumer products. In further embodiments, the real time server conducted search uses close captioning information related to the content or meta data related to the content. In some embodiments, the rendering content includes displaying a television show or a movie.

These and other objects and advantages of the various embodiments of the present invention will be recognized by those of ordinary skill in the art after reading the following detailed description of the embodiments that are illustrated in the various drawing figures.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 is a graphical depiction of an exemplary system for displaying information of specific interest to a user, according to an embodiment of the present invention.

FIGS. 2A and 2B are graphical depictions of the exemplary system displaying user requested information, according to an embodiment of the present invention.

FIGS. 3A and 3B are graphical depictions of the exemplary system displaying user selected additional information, according to an embodiment of the present invention.

FIGS. 4A and 4B are graphical depictions of the exemplary system displaying user requested purchase information, according to an embodiment of the present invention.

FIG. 5A is a block diagram of an example of a general purpose television system within which a system of displaying information of specific interest to a user in accordance with the present invention can be implemented.

FIG. 5B is a block diagram of an example of a general purpose communication system within which a system of displaying information of specific interest to a user in accordance with the present invention can be implemented.

FIG. 6 depicts a flowchart of an exemplary television controlled method of displaying information of specific interest to a user, according to an embodiment of the present invention.

FIG. 7 depicts a flowchart of an exemplary television controlled method of displaying information and advertising of specific interest to a user, according to an embodiment of the present invention.

### DETAILED DESCRIPTION

Reference will now be made in detail to embodiments in accordance with the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

The drawings showing embodiments of the system are semi-diagrammatic and not to scale and, particularly, some of the dimensions are for the clarity of presentation and are shown exaggerated in the drawing Figures. Also, where multiple embodiments are disclosed and described having some features in common, for clarity and ease of illustration, description, and comprehension thereof, like features one to another will ordinarily be described with like reference numerals.

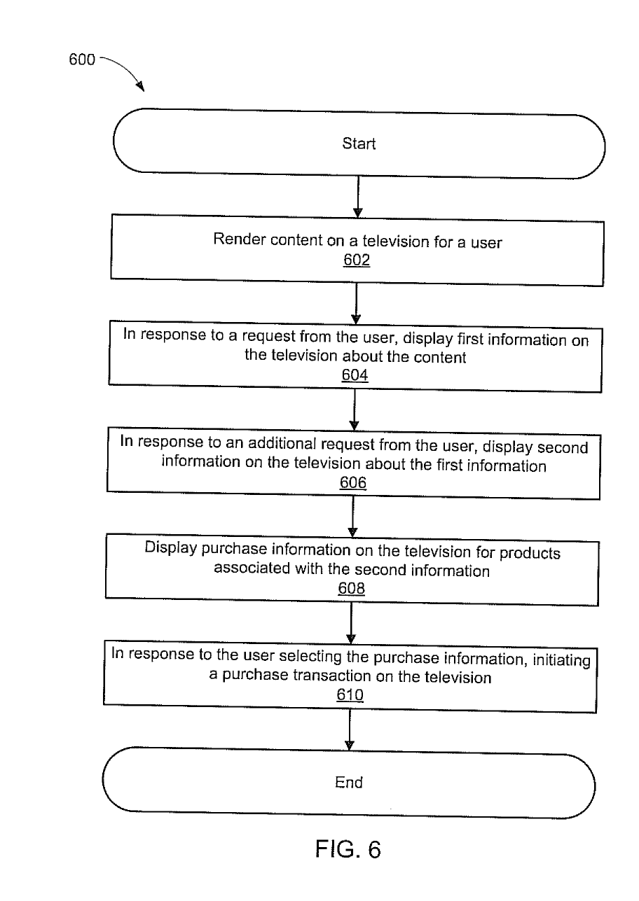

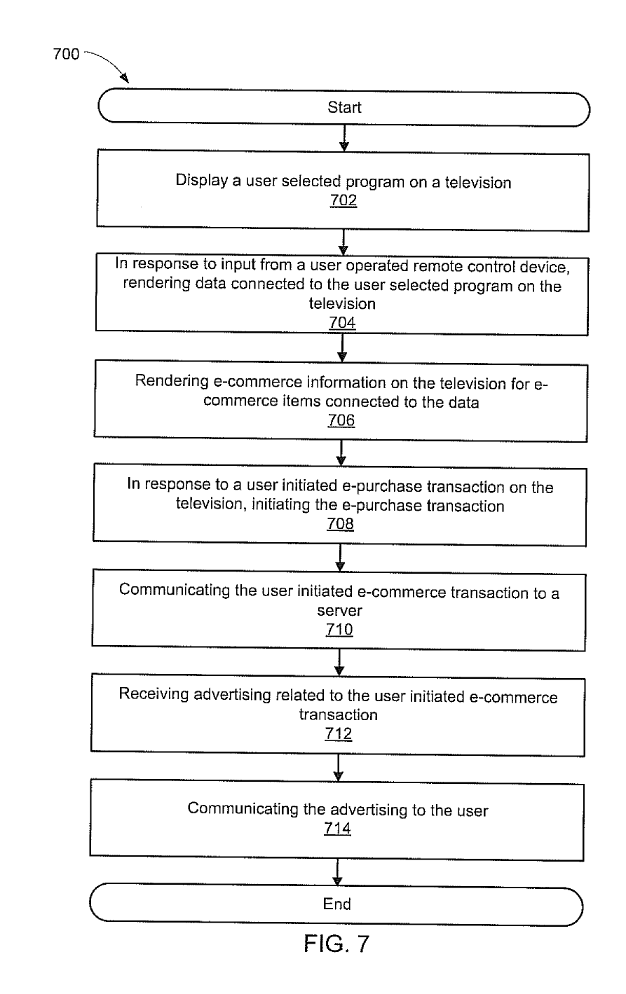

Some portions (e.g. FIG. 6 and FIG. 7) of the detailed descriptions, which follow, are presented in terms of procedures, steps, simulations, calculations, logic blocks, processing, and other symbolic representations of operations on data within a television system. These descriptions and representations are the means used by those skilled in the data processing arts to most effectively convey the substance of their work to others skilled in the art. A procedure, television-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a television system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions refer to the actions and processes of a television system, or similar electronic device, that manipulates and transforms data represented as physical (electronic) quantities within the television system's registers and memories into other data similarly represented as physical quantities within the television system memories or registers or other such information storage, transmission, or display devices.

### Method and System of Displaying Information of Specific Interest to a User on a Television

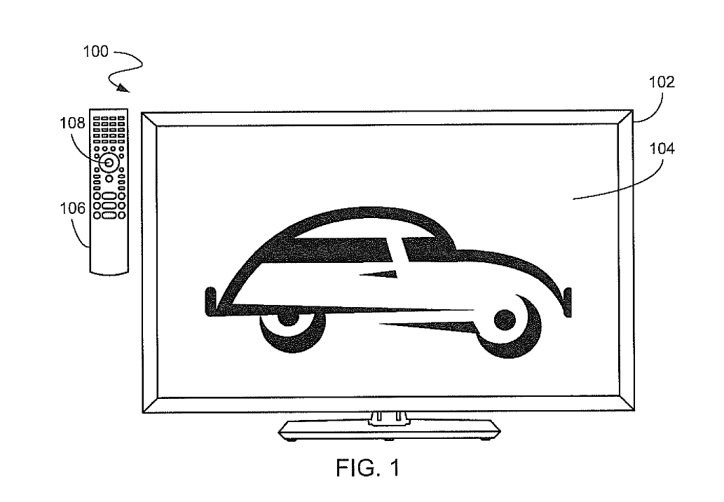

FIG. 1 is a graphical depiction of an exemplary system 100 for displaying information of specific interest to a user, according to an embodiment of the present invention. The system 100 allows users to have easy access to searching and purchasing items related to content, e.g. a program, etc., that is currently being viewed. The system 100 presents on the display screen searched and filtered information based on a correlation to content being viewed by a user. In addition, the system 100 initiates a user selected purchase transaction for items related to the content being viewed. The purchase is completed via a remote server, in one embodiment.

A television 102 displays content 104 to a user (not shown). For example, the content 104 may be a movie, a television program, internet streaming video, etc. The user may control the television 102 with a remote control device 106. The remote control device 106 may be any device capable of controlling the television 102. For example, the remote control device 106 may be an UR remote control device, a LAN remote control device, or an application on a smart phone.

While viewing the content 104, the user may be interested in information related to the content 104. The user may then select a “more information” button 108 on the remote control device 106. In an embodiment the more information button 108 pauses the content 104 before displaying more information.

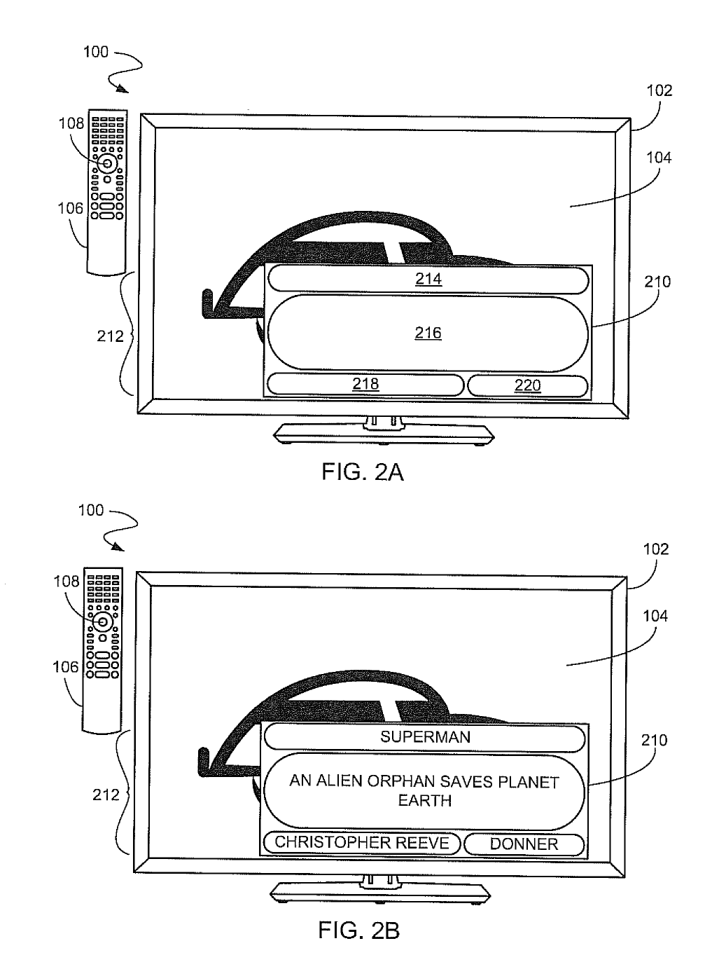

FIGS. 2A and 2B are graphical depictions of the exemplary system 100 displaying user requested information, according to an embodiment of the present invention. In response to the user selecting the more information button 108, the system 100 displays a more information screen 210 on the television 102 with detailed information about the content 104. The detailed information screen 210 may be displayed over a portion of the content 104 or over all of the content 104 in a special display. In an embodiment, the more information screen 210 may be displayed on the remote control device 106.

Thus for example, in FIG. 2B the user is watching a movie about a superhero. The user may wish to get more information about the movie, so the user selects the more information button. In response, the television displays the title of the movie, a summary of the movie, the actors in the movie, the director of the movie, etc.

Therefore, the more information screen 210 may display detailed information 212 about the content 104. The detailed information 212 may be received from close captioning, meta data, or an external server. In an embodiment, the detailed information 212 is information specific to the content 104 and may be selectable for further information. For example, the detailed information 212 may include a selectable title 214, a selectable plot summary 216, a selectable actor list 218, and a selectable director list 220.

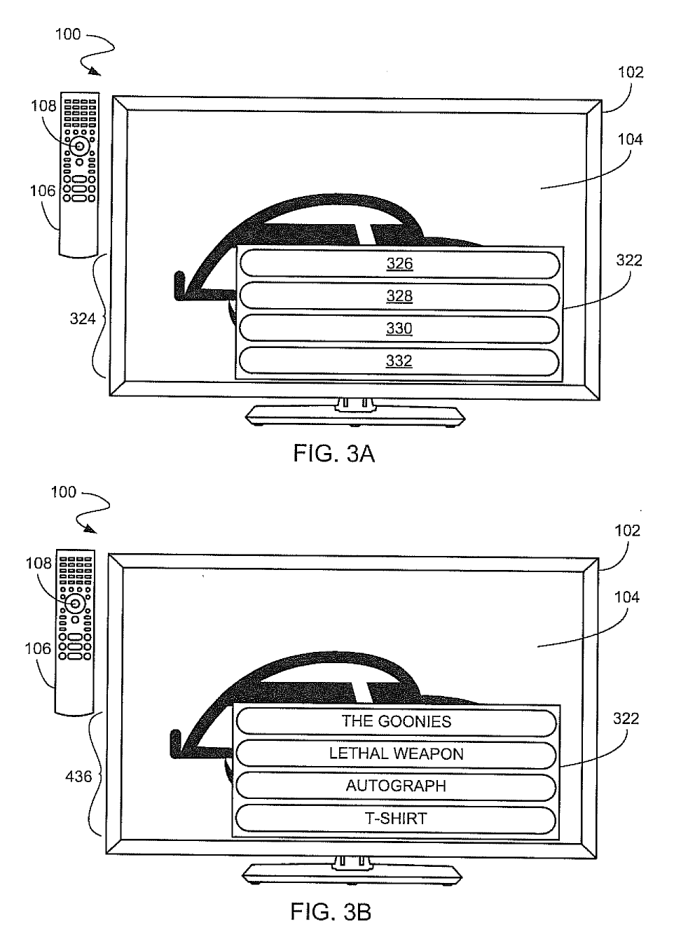

FIGS. 3A and 3B are graphical depictions of the exemplary system 100 displaying user selected additional information, according to an embodiment of the present invention. In response to the user selecting a portion of the detailed information 212 (See FIG. 2), the system 100 displays a second information screen 322 on the television 102 with more information about the user selected portion of the detailed information 212 (See FIG. 2). The second information screen 322 may be displayed over a portion of the content 104 or over all of the content 104. In an embodiment, the second information screen 322 may be displayed on the remote control device 106.

Thus for example, in FIG. 3B the user is watching the movie about the superhero. The user got more information about the movie by selecting the more information button. In response, the television displayed the title of the movie, a summary of the movie, the actors in the movie, the director of the movie, etc. Now the user wishes to see if the director has directed other movies, and selects the director's name. In response, the television displays a list of movies and television shows that the director has directed available for purchase. In addition, the television displays an autographed picture of the director available for purchase, and a t-shirt with a portrait of the director, also available for purchase.

Therefore, the second information screen 322 displays related information 324 about the detailed information 212 (See FIG. 2). For example, the related information 324 may include titles of movies related to the title of the content 104, titles of television programs with plots similar to the plot of the content 104, titles of other performances containing one or more of the actors of the content 104, or titles of other movies the director of the content 104 has directed. In addition, the related information 324 may contain consumer products available for purchase. A consumer product is any tangible property for sale that is used for personal, family, or household purposes.

The system 100 receives the related information 324 from a remote server (not shown) conducting a real-time search. The server may use close captioning, meta data, or previously stored data related to the content 104 to conduct key word searches and filtering. In such case, the television will communicate key words to the server indicating the viewed content and/or any on screen selections made by the user. In addition, programs running on the server may further refine or shape search results. The server returns the results of the search to the system 100, e.g. via the web.

Thus in an embodiment, the related information screen 322 may contain a first movie button 326, a second movie button 328, a television program button 330, and a consumer product button 332. In alternate embodiments, any number of buttons in any order or combination may be used. The buttons list products available for purchase and may include movies, television programs, consumer products, etc. The buttons are selectable by the user with the remote control device 106.

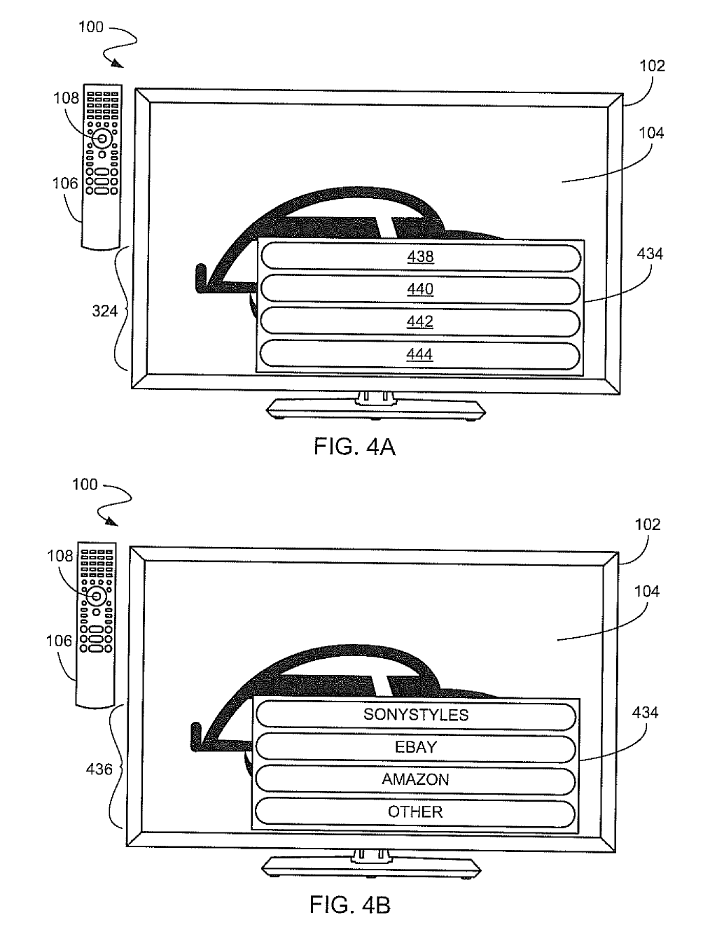

FIGS. 4A and 4B are graphical depictions of the exemplary system 100 displaying user requested purchase information, according to another embodiment of the present invention. In response to the user selecting a portion of the related information 324 (See FIG. 3), the system 100 displays purchase information screen 434 on the television 102. The purchase information screen 434 may be displayed over a portion of the content 104 or over all of the content 104. In an embodiment, the purchase information screen 434 may be displayed on the remote control device 106.

Thus for example, in FIG. 4B the user is watching the movie about the superhero. The user received more information about the movie by selecting the more information button. In response, the television displayed the title of the movie, a summary of the movie, the actors in the movie, the director of the movie, etc. The user wished to see if the director had directed other movies, and selected the director's name. In response, the television displayed the list of movies and television shows that the director had directed available for purchase. In addition, the television displayed the autographed picture of the director available for purchase, and the t-shirt with a portrait of the director, also available for purchase.

Now the user wishes to purchase the autographed picture of the director, and selects the autographed picture. In response the television displays a list of online vendors (for example, SonyStyles, eBay, Amazon, etc.) and the cost of the autographed picture from each vendor. The user may select a desired vendor and the television will initiate a purchase transaction for the autographed picture. The purchase is completed via the back end server communicating directly with the vendor site.

Therefore, the purchase information screen 434 displays purchase information 436 for one or more items from the second information screen 322 (See FIG. 3). For example, the purchase information 436 may include a first vendor button 438, a second vendor button 440, a third vendor button 442, and a fourth vendor button 444. In alternate embodiments, any number vendor buttons may be used. The buttons are selectable by the user with the remote control device 106.

In response to the user selecting the first vendor button 438, the second vendor button 440, the third vendor button 442, or the fourth vendor button 444, the system 100 initiates an e-commerce transaction from the television 102. The e-commerce transaction is an e-purchase transaction for one or more items selected from the second information screen 322 (See FIG. 3). E-purchase transactions may be initiated for items including recorded media of television shows, recorded media of movies, consumer products, etc. The e-commerce transaction is completed via the remote server communicating directly with a vendor.

In an embodiment, the server stores a record of the user's transaction history. The system 100 may then receive advertising related to the user's transaction history and display the advertising on the television 102. The advertising may be shown at designated times, e.g. during specific times of the day, during power up/down, during holiday seasons, before a movie, etc. In an embodiment, portions of the advertising are selectable to initiate further e-commerce transactions.

In another embodiment, the user may purchase virtual currency on the server. The virtual currency may be used for e-commerce transactions from online vendors (for example, SonyStyles, eBay, Amazon, etc.), when the e-commerce transactions are initiated on the television 102. In a further embodiment, the user may earn the virtual currency by completing activities, e.g. watching random advertising. For example, the user may purchase “Sony Bucks” using US Dollars. The user may earn additional “Sony Bucks” by watching an hour of advertising. The user may use the “Sony Bucks” to complete purchases on a television from online vendors, instead of US Dollars.

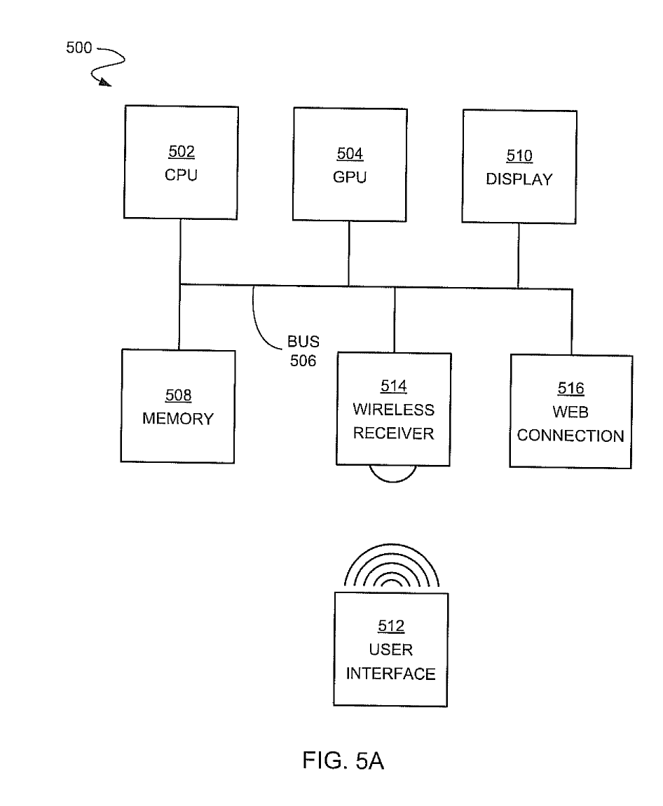

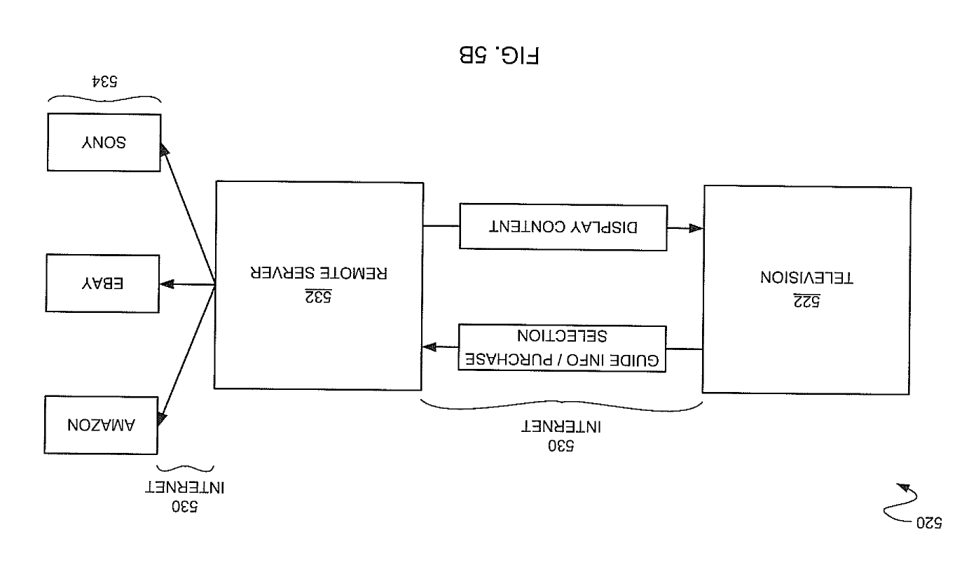

FIG. 5A is a block diagram of an example of a general purpose television system 500 within which a system of displaying information of specific interest to a user in accordance with the present invention can be implemented. In the example of FIG. 5, the system includes a host central processing unit (CPU) 502 coupled to a graphics processing unit (GPU) 504 and a web connection 516 via a bus 506. One or more CPUs as well as one or more GPUs may be used. The web connection 516 may be, for example, an Ethernet port, a cable modem, a DSL modem, etc.

Both the CPU 502 and the GPU 504 are coupled to memory 508. In the example of FIG. 5, the memory 508 may be a shared memory, whereby the memory stores instructions and data for both the CPU 502 and the GPU 504. Alternatively, there may be separate memories dedicated to the CPU 502 and GPU 504, respectively. In an embodiment, the memory 508 includes the system of displaying information of specific interest to a user in accordance with the present invention. The memory 508 can also include a video frame buffer for storing pixel data that drives a coupled display device 510.

The system 500 also includes a user interface 512 that, in one implementation, includes an on-screen control device. The user interface may include an UR remote control device, a LAN remote control device, or an application on a smart phone. The user interface 512 may be a wired interface (not shown) or a wireless interface communicating to a wireless receiver 514.

Generally speaking, the system 500 includes the basic components of a television system platform that implements functionality in accordance with embodiments of the present invention. The system 500 can be implemented as, for example, any of a number of different types of television systems (e.g., LED, Plasma, LCD, OLED, and CRT), as well as a home entertainment system (e.g., a DVD player) such as a set-top box or digital television, or a portable or handheld electronic device (e.g., a portable phone, personal digital assistant, handheld gaming device, or laptop computer).

FIG. 5B is a block diagram of an example of a general purpose communication system 520 within which a system of displaying information of specific interest to a user in accordance with the present invention can be implemented. In the example of FIG. 5B, the system includes a television system 522. The television system 522 communicates over the internet 530 to a remote server 532, when a user requests more information or makes a purchase selection.

If the user requests more information, the television system 522 packages relevant guide information, e.g. from close captioning or meta data, and transmits the information to the remote server 532 via the internet 530. The remote server 532 uses the guide information for key words to perform a real time search. The remote server 532 transmits the results of the search back to the television system 522 via the internet 530.

If the user makes a purchase selection, the television system 522 transmits the purchase request to the remote server 532. The remote server 532 completes the transaction with a vendor 534, e.g. Amazon, eBay, Sony, etc., via the internet 530. The remote server 532 transmits the completed transaction results back to the television system 522 via the internet 530.

FIG. 6 depicts a flowchart 600 of an exemplary television controlled method of displaying information of specific interest to a user, according to an embodiment of the present invention. Although specific steps are disclosed in the flowchart 600, such steps are exemplary. That is, embodiments of the present invention are well-suited to performing various other steps or variations of the steps recited in the flowchart 600.

In a step 602, content is rendered on a television for a user. In an embodiment, the rendered content includes displaying a television show or a movie. For example, in FIG. 1 a user watches a movie, a television show, or streaming internet content on a television. The user controls the television with a wireless remote control.

In a step 604, in response to a request from the user, first information is displayed on the television about the content. In an embodiment, displaying the first information includes displaying title information, actor information, description information, date information, etc. For example, in FIG. 2 the user is watching a movie and selects the more information button on the remote control. The television then uses guide information, e.g. meta data, close captioning, etc., to display the title of the movie, a summary of the movie, the actors in the movie, and the director of the movie.

In a step 606, in response to an additional request from the user, second information is displayed on the television about the first information, wherein the second information is acquired from a real time server conducted search. In some embodiments, the real time server conducted search uses close captioning information or meta data related to the content to perform the search. In various embodiments, displaying the second information includes displaying a number of titles within a common genre, a number of titles an actor has appeared in, or a number of titles a director has directed.

For example, in FIG. 3 the user requested to see additional information about the director. The television packaged guide information, e.g. meta data, close captioning, etc., and transmitted the guide information to a remote server. A remote server conducted a real time search based on keywords from the guide information, and returned the results to the television. The television displayed a list of movies and television shows directed by the director and available for purchase. In addition, the television displayed autographed pictures and t-shirts, also available for purchase.

In a step 608, purchase information is displayed on the television for products associated with the second information. In an embodiment the products include recorded media of television shows, recorded media of movies, or consumer products. For example, in FIG. 4 the user wanted to purchase an autographed picture of the director. The user selected the autographed picture and the television displayed a list of online vendors and the cost of the autographed picture from each vendor. However, the user might have instead been interested in a particular movie directed by the director. In that case, the television would have displayed a list of online vendors and the cost of the movie from each vendor.

In a step 610, in response to the user selecting the purchase information, a purchase transaction is initiated on the television. For example, in FIG. 4 the user selected a vendor listed on the television from which to buy the autographed picture. The television initiated the purchase transaction, and the purchase transaction was completed by the server.

FIG. 7 depicts a flowchart 700 of an exemplary television controlled method of displaying information and advertising of specific interest to a user, according to an embodiment of the present invention. Although specific steps are disclosed in the flowchart 700, such steps are exemplary. That is, embodiments of the present invention are well-suited to performing various other steps or variations of the steps recited in the flowchart 700.

In a step 702, a user selected program is displayed on a television. In an embodiment, displaying a user selected program includes displaying a television program or a movie. For example, in FIG. 1 a user watches a movie, a television show, or streaming internet content on a television.

In a step 704, in response to input from a user operated remote control device, data connected to the user selected program is rendered on the television. In an embodiment, the user operated remote control device is an UR remote control, a LAN remote control, or an application on a smart phone. In some embodiments, rendering the data includes rendering a number of programs within a common genre, programs with a common actor, or programs with related directors.

For example, in FIG. 2 and FIG. 3 the television uses guide information, e.g. close captioning, meta data, etc., to display the title of the movie, a summary of the movie, the actors in the movie, and the director of the movie. In addition, the television may display titles of related movies, titles of television programs within the same genre, titles of other performances containing one or more of the actors, titles of other movies the director has directed, or related consumer products.

In further embodiments the data is received over the internet from a server. For example, in FIG. 3 the television received search information from a server conducting a real time search. The server used data from the program's close captioning or meta data to do the search. In addition, programs running on the server shaped the search results. The search results were then transmitted from the server to the television and presented to the user.

In a step 706, e-commerce information is rendered on the television for e-commerce items connected to the data. For example, in FIG. 4 the user wanted to purchase an autographed picture of the director. The user selected the autographed picture and the television displayed a list of online vendors and the cost of the autographed picture from each vendor.

In a step 708, in response to a user initiated e-purchase transaction on the television, the e-purchase transaction is initiated. For example, in FIG. 4 the user selected a vendor listed on the television from which to buy the autographed picture. In response to the user's selection, the television initiated the purchase transaction.

In a step 710, the user initiated e-commerce transaction is communicated to a server. For example, in FIG. 4 after the user initiates the purchase on the television, the purchase transaction is completed by the server. The server may use either virtual currency or government currency to complete the transaction.

In a step 712, advertising related to the user initiated e-commerce transaction is received. For example, the server may store a record of the user's transaction history. The server automatically selects targeted advertising based on the user's transaction history and transmits the advertising to the television. The television may immediately show the advertising or store the advertising in memory for playback at server determined times.

In a step 714, the advertising is communicated to the user. For example, the server communicates to the television designated times to play the advertising, e.g. during specific times of the day, during power up/down, during holiday seasons, before a movie, etc. The television plays the advertising for the user, based on the directions from the server. The advertising may be stored on the television for later use or deleted from memory.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

What is claimed is:

1. A method of displaying information of specific interest to a user, said method comprising:
rendering content on a television for a user;
in response to a request from said user, displaying first information on said television about said content;
in response to an additional request from said user, displaying second information on said television about said first information, wherein said second information is acquired from a real time server conducted search;
displaying purchase information on said television for products associated with said second information; and
in response to said user selecting said purchase information, initiating a purchase transaction on said television.

2. The method of claim 1 wherein said displaying first information comprises displaying title information, actor information, description information, and date information.

3. The method of claim 1 wherein said displaying second information comprises displaying a plurality of titles within a common genre, a plurality of titles an actor has appeared in, or a plurality of titles a director has directed.

4. The method of claim 1 wherein said products comprise one of recorded media of television shows, recorded media of movies, and consumer products.

5. The method of claim 1 wherein said real time server conducted search uses close captioning information related to said content to perform said search.

6. The method of claim 1 wherein said real time server conducted search uses meta data related to said content to perform said search.

7. The method of claim 1 wherein said rendering content comprises displaying one of a television show and a movie.

8. A method comprising:
displaying a user selected program on a television;
in response to input from a user operated remote control device, rendering data on said television connected to said user selected program;
rendering e-commerce information on said television for e-commerce items connected to said data; and
in response to a user initiated e-purchase transaction on said television, initiating said e-purchase transaction.

9. The method of claim 8 wherein said rendering data comprises rendering a plurality of programs within a common genre, programs with a common actor, or programs with related directors.

10. The method of claim 8 wherein said user operated remote control device is one of a UR remote control, a LAN remote control, and an application on a smart phone.

11. The method of claim 8 wherein said e-commerce items comprise one of recorded media of television shows, recorded media of movies, and consumer products.

12. The method of claim 8 further comprising receiving said data over the internet from a server.

13. The method of claim 8 further comprising:
communicating said user initiated e-commerce transaction to a server;
receiving advertising related to said user initiated e-commerce transaction; and
communicating said advertising to said user.

14. The method of claim 8 wherein said displaying a user selected program comprises displaying one of a television program and a movie.

15. A television comprising:
a processor;
a display device coupled to said processor;
an input device wirelessly connected to said processor; and
memory coupled to said processor, wherein said memory comprises instructions that when executed cause said system to perform a method of displaying information of specific interest to a user, said method comprising:
rendering content on said display device for a user;
in response to a request from said user, displaying first information on said display about said content;
in response to an additional request from said user, displaying second information on said display about said first information, wherein said second information is acquired from a real time server conducted search;
displaying purchase information on said display for products associated with said second information; and
in response to said user selecting said purchase information, initiating a purchase transaction.

16. The television of claim 15 wherein said displaying first information comprises displaying title information, actor information, description information, and date information.

17. The television of claim 15 wherein said displaying second information comprises displaying a plurality of titles within a common genre, a plurality of titles an actor has appeared in, or a plurality of titles a director has directed.

18. The television of claim 15 wherein said products comprise one of recorded media of television shows, recorded media of movies, and consumer products.

19. The television of claim 15 wherein said real time server conducted search uses close captioning information related to said content or meta data related to said content.

20. The television of claim 15 wherein said rendering content comprises displaying one of a television show and a movie.
